(19) United States
(12) Patent Application Publication
(10) Pub. No.: US 2026/0214055 A1
(43) Pub. Date: Jul. 23, 2026

(54) ANALYTICS RELATED TO A VIRTUAL EXPERIENCE APPLICATION SERVICE IN A WIRELESS COMMUNICATION SYSTEM

(71) Applicant: Lenovo (Singapore) Pte. Ltd., Singapore (SG)

(72) Inventors: Emmanouil Pateromichelakis, Viersen (DE); Dimitrios Karampatsis, Ruislip (GB)

(21) Appl. No.: 19/139,077

(22) PCT Filed: Feb. 24, 2023
(86) PCT No.: PCT/EP2023/054720

§ 371 Date: Jun. 13, 2025

(30) Foreign Application Priority Data
Dec. 16, 2022 (GR) 20220101050

(51) Int. Cl. H04L 47/2416; H04L 47/2475; H04W 28/02; H04W 28/06

(52) U.S. Cl. CPC H04L 47/2416; H04L 47/2475; H04W 28/0236; H04W 28/06

(57) ABSTRACT

There is provided a method in an application entity of a wireless communication system, the method for determining analytics (e.g. application QoS analytics) in relation to a virtual experience application service or session. The method comprises: receiving, from an analytics consumer, a request for the analytics related to the virtual experience application service; for each of one or more traffic profiles of traffic within the virtual experience application service, determining at least one data source for providing data; for each of the one or more traffic profiles within the virtual experience application service, obtaining data from the at least one data source determined for that traffic profile; for each of the one or more traffic profiles within the virtual experience application service, deriving the analytics based on the obtained data; and sending, to the analytics consumer, the derived analytics.

### FIELD

The subject matter disclosed herein relates generally to the field of deriving and implementing analytics in a wireless communication network or system, in particular analytics related to a virtual experience application service or session, such to the performance or service quality of the as performance virtual experience application service or session.

### INTRODUCTION

Herein, the expression “virtual experience” is an umbrella term for different types of virtual realities, including but not limited to eXtended Reality (XR), Virtual Reality, Augmented Reality, Mixed Reality the Metaverse. XR may be used itself as an umbrella term for different types of realities of which Virtual Reality, Augmented Reality, and Mixed Reality are examples.

Virtual experience application traffic is subject to strict bandwidth and latency limitations in order to deliver an appropriate Quality of Service and Quality of Experience to an end user of a virtual experience application service. Such strict bandwidth and latency limitations can make delivery of virtual experience application traffic over a wireless communication network challenging.

### SUMMARY

In the context of virtual experience, and in particular XR media traffic, 3GPP SA2 Work Group recently introduced the concept of a ‘PDU set’ to group a series of PDUs carrying a unit of information at the application-level. Each PDU within a PDU set can thus be treated according to an identical set of QoS requirements and associated constraints of delay budget and error rate while providing support to a RAN for differentiated QoS handling at PDU set level. This improves the granularity of legacy 5G QoS flow framework allowing the RAN to optimize the mapping between QoS flow and DRBs to meet stringent XR media requirements (e.g., high-rate transmissions with short delay budget).

Disclosed herein are procedures for collecting data related to virtual experience specific attributes and deriving performance analytics per traffic profiles of traffic within a virtual experience application session or service (e.g. PDU set, media or traffic type, or even per XR session). Said procedures may be implemented by application entity.

There is provided an a method in an application entity of a wireless communication system, the method for determining analytics in relation to a virtual experience application service, the method comprising: receiving, from an analytics consumer, a request for the analytics related to the virtual experience application service; for each of one or more traffic profiles of traffic within the virtual experience application service, determining at least one data source for providing data; for each of the one or more traffic profiles within the virtual experience application service, obtaining data from the at least one data source determined for that traffic profile; for each of the one or more traffic profiles within the virtual experience application service, deriving analytics based on the obtained data; and sending, to the analytics consumer, the derived analytics.

There is further provided an application entity for a wireless communication system, the application entity comprising: a transceiver; and a processor coupled to the transceiver, the processor and the transceiver configured to cause the application entity to: receive, from an analytics consumer, a request for the analytics related to a virtual experience application service; for each of one or more traffic profiles of traffic within the virtual experience application service: determine at least one data source for providing data, obtain data from the at least one data source determined for that traffic profile, and derive analytics based on the obtained data; and send, to the analytics consumer, the derived analytics.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for collecting data related to virtual experience specific attributes and deriving performance analytics per traffic profile will now be described, by way of example only, with reference to the accompanying drawings, in which:

FIG. 1 depicts a wireless communication system;

FIG. 2 depicts a user equipment apparatus;

FIG. 3 depicts a network node;

FIG. 4 illustrates an overview of a core network architecture handling of PDU sets;

FIG. 5 illustrates an exemplary XR enabler service;

FIG. 6 illustrates a mechanism for XR Media (XRM) tailored service optimization using analytics;

FIG. 7 illustrates a process in which an XR analytics are derived or obtained; and

FIG. 8 is a process flow chart showing certain steps of a method in which XR analytics are derived or obtained.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

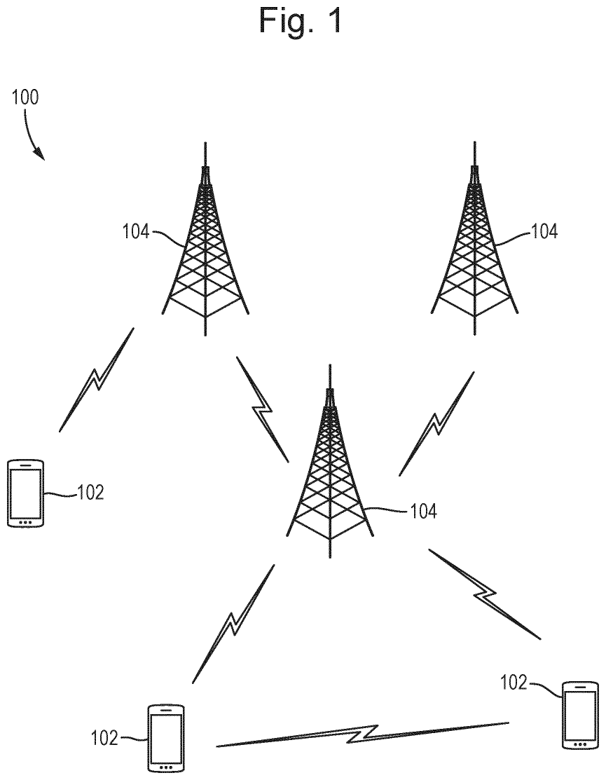

FIG. 1 depicts an embodiment of a wireless communication system 100 in which methods and apparatuses for collecting data related to XR specific attributes and deriving performance analytics per traffic profiles of traffic within a virtual experience application session or service (e.g. XR application session) may be implemented.

It will be appreciated by those skilled in the art that a virtual experience (e.g. XR) application runs a virtual experience (e.g. XR) application service or session. The virtual experience (e.g. XR) application can be, for example, a server application, an application function, a device application, or a combination thereof.

In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

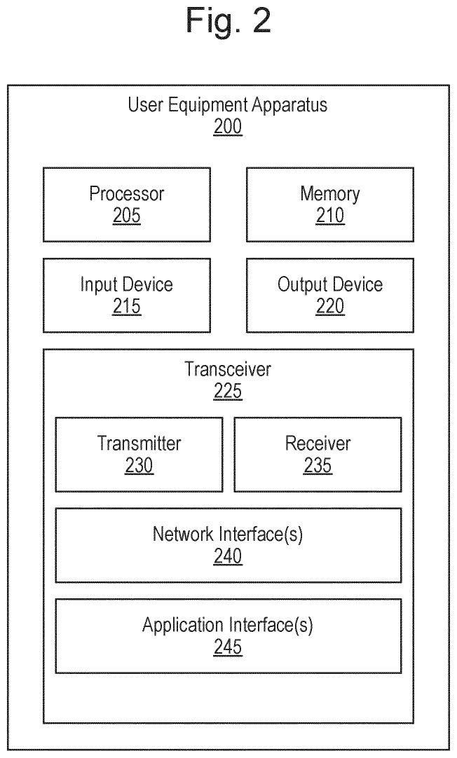

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be in accordance with or the same as the remote unit 102 of FIG. 1. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication system via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication system. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication system over licensed radio spectrum and a second transmitter/receiver pair used to communicate with a mobile communication system over unlicensed radio spectrum.

The first transmitter/receiver pair may be used to communicate with a mobile communication system over licensed radio spectrum and the second transmitter/receiver pair used to communicate with a mobile communication system over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

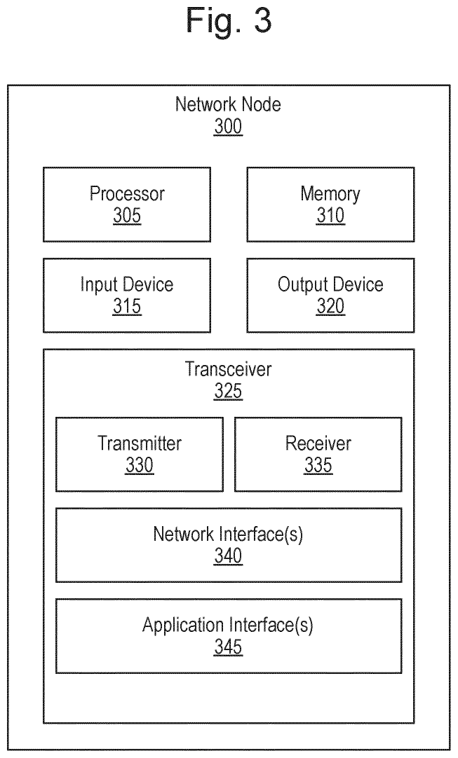

FIG. 3 depicts further details of the network node 300 that may be used for implementing the methods described herein. The network node 300 may be one implementation of an entity in the wireless communications system or network, e.g. in one or more of the wireless communications networks described herein, e.g. the wireless communication system 100 of FIG. 1. In particular, the network node 300 may be in accordance with or the same as the network unit 104 of FIG. 1. The network node 300 may be, for example, the UE apparatus 200 described above, or a Network Function (NF) or Application Function (AF), or another entity, of one or more of the wireless communications networks of embodiments described herein, e.g. the wireless communication system 100 of FIG. 1. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

In Release 18, 3GPP is studying enhancements to support XR (extended reality) media within 3GPP core network. The main principle of solutions being discussed is to allow the core network to guarantee delivery of media packets that are important at the application level for recovering the media traffic even when the media packet is sent via a best effort bearer.

Most of the solutions proposes in 3GPP SA2 propose that the network identify important packets in a PDU-set. The PDU-set terminology in 3GPP TR 23.700-60 is as follows:
PDU Set: A PDU Set is composed of one or more PDUs carrying the payload of one unit of information generated at the application level (e.g. a frame or video slice for XRM Services, as used in TR 26.926. In some implementations all PDUs in a PDU Set are needed by the application layer to use the corresponding unit of information. In other implementations, the application layer can still recover parts all or of the information unit, when some PDUs are missing.

PDU-set specific QoS requirements may be defined that are either pre-configured in the 3GPP core network or provided by an AF. The QoS requirements for a PDU-set may be defined using any combination of the following parameters:
PDU Set Delay Budget (PSDB);
PDU Set Error Rate (PSER); and
Whether a PDU is essential.

The term PDU Set Delay Budget (PSDB) is used herein to define an upper bound for the time that a PDU-Set may be delayed between the UE and the N6 termination point at the UPF. PSDB applies to the DL PDU-Set received by the UPF over the N6 interface, and to the UL PDU-Set sent by the UE.

The term PDU Set Error Rate (PSER) is used herein to define a ratio of dropped PDU-set by NG-RAN compared to total PDU-set sent to the UE.

Whether a PDU is essential indicates whether all PDUs of a PDU-set are required by a receiver.

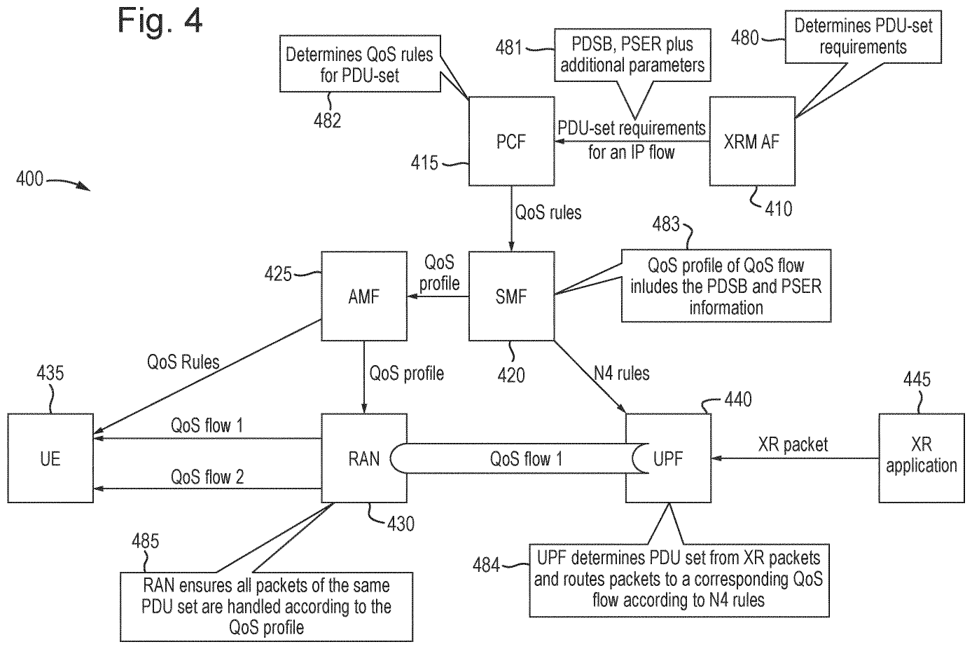

The packets belonging to a PDU-set are handled by the core network as shown in FIG. 4 which illustrates an overview of a core network (CN) XRM architecture handling of PDU sets. FIG. 4 shows a system 400 comprising an Extended Reality Media Application Function (XRM AF) 410, a Policy and Control Function (PCF) 415, a Session Management Function (SMF) 420, an Access and Mobility Function (AMF) 425, a Radio Access Network (RAN) 430, a User Equipment (UE) 435, a User Plane Function (UPF) 440, and an Extended Reality Application 445. The UE 435 may comprise a remote unit 102 or a user equipment apparatus 200 as described herein. The RAN 430 may comprise a base unit 104 or a network node 300 as described herein. The operation of system 400 will now be described in the example of downlink traffic, a similar process may operate for uplink traffic.

At 480, the XRM AF 410 determines PDU set requirements.

At 481, the XRM Application Function 410 provides QoS requirements for packets of a PDU set to the PCF 415 and information to identify the application (i.e. 4-tuple or application ID). The QoS requirements may comprise PSDB and PSER. The XRM AF 410 may also include an importance parameter for a PDU set and information for the core network to identify packets belonging to a PDU set.

At 482, the PCF 415 derives QoS rules for the XR application and specific QoS requirements for the PDU set. The QoS rules may use a 4G QoS identifier (5QI) for XR media traffic. The PCF 415 sends the QoS rules to the SMF 420. The PCF 415 may include in the communication to the SMF 420 Policy and Charging Control (PCC) rules per importance of a PDU set. The PCC rules may be derived according to information received from the XRM AF 410 or based on an operator configuration.

At 483, the SMF 420 establishes a QoS flow according to the QoS rules by the PCF 415 and configures the UPF to route packets of the XR application to a QoS flow, and, in addition, to enable PDU set handling. The SMF 420 also provides the QoS profile containing PDU set QoS requirements to the RAN 430 via the AMF 425. The AMF 425 may provide the QoS profile containing PDU set QoS requirements to the RAN 430 in an N2 Session Management (SM) container. Further, the AMF 425 may provide the QoS rules to the UE 435 in an N1 SM container.

At 484, the UPF 440 inspects the packets and determines packets belonging to a PDU set. The packet inspection may comprise inspecting the RTP packets. When the UPF 440 detects packets of a PDU set the UPF 440 marks the packets belonging to a PDU set within a GTP-U header. The GTP-U header information includes a PDU set sequence number and the size of the PDU set. The UPF 440 may also determine the importance of the PDU set either based on UPF 440 implementation means, information provided by the XRM AF 410 or information provided as metadata from an XRM application server. Based on the importance of the PDU set the UPF 440 may route the traffic to a corresponding QoS flow 1 (according to the rules received from the SMF 420) or include the importance of the PDU set within a GTP-U header. QoS flow 1 may comprise GTP-U headers, and these may include PDU set information.

At 485, the RAN 430 identifies packets belonging to a PDU set (based on the GTP-U marking) and handles the packets of the PDU set according to the QoS requirements of the PDU set provided by the SMF 420. RAN 430 may receive QFIs, QoS profile of QoS flow from SMF 420 (via AMF 425) during PDU session establishment/modification which includes PDSB and PSER. RAN 430 inspects GTP-U headers and ensures all packets of the same PDU set are handled according to the QoS profile. This may include packets of PDU set in a radio bearer carrying QoS flow 1. This may also include sending packets not belonging to the PDU set in a different radio bearer carrying QoS flow 2.

The above example relates to downlink (DL) traffic. Reciprocal processing is applicable to uplink (UL) traffic wherein the role of UPF 440 packet inspection is taken by the UE 435 which is expected to inspect uplink packets, determine packets belonging to a PDU set, and signal accordingly the PDU set to the RAN 430 for scheduling and resource allocation corresponding to an associated DRB capable of fulfilling the PDU set QoS requirements (i.e., PSDB and PSER). The low-level signaling mechanism associated with the UL UE-to-RAN information passing are up to the specification and implementations of RAN signaling procedures.

Herein, eXtended Reality (XR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, 3GPP SA4 Working Group analyzed the Media transport Protocol and XR traffic model in the Technical Report TR 26.926 (v1.1.0) tided “Traffic Models and Quality Evaluation Methods for Media and XR Services in 5G Systems”, and decided the QoS requirements in terms of delay budget, data rate and error rate necessary for a satisfactory experience at the application level. These led to 4 additional 5G QoS Identifiers (5QIs) for the 5GS XR QoS flows. These 5Qis are defined in 3GPP TS 23.501 (v17.5.0), Table 5.7.4-1, presented there as delay-critical GBR 5QIs valued 87-90. The latter are applicable to XR video streams and control metadata necessary to provide the immersive and interactive XR experiences.

The XR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.).

The following additional assumptions have also been agreed:
NG-RAN is the only entity that drops packet of a PDU-set in case of congestion.
For a QoS flow there can be multiple priority PDU-sets. The NG-RAN drops the lower priority PDU-sets in case of congestions
The NG-RAN drops all PDUs of a PDU-set

The Analytics Consumer NF may be one or more of an AF, OAM and 5G Core NFs (e.g., SMF, AMF, PCF). A full list of potential Analytics Consumer NF for each Analytics output the NWDAF provides is described in table 1 below.

TABLE 1
Example Analytics Consumer NFs

| | Example Analytics |
|---|---|
| NWDAF Analytics Output | Consumer NF |
| Slice Load Level | PCF, NSSF |
| Observed Service Experience | PCF, OAM |
| NF load analytics | All 5G core NFs, OAM |
| Network Performance Analytics | PCF, NEF, AF, or OAM |
| UE Mobility Analytics | AMF, SMF |
| UE Communication Analytics | AMF, SMF, PCF |
| Expected UE behavioural analytics | AMF, UDM, AF or OAM |
| Abnormal behaviour analytics | AMF, SMF, PCF |
| User Data Congestion analytics | NEF, AF |
| QoS Sustainability Analytics | AF |

In particular, to support XR services, the following analytics are relevant to this disclosure. Such analytics can be beneficial for mobile XR users, or for the XR service provider/vertical who needs to deploy the XRM service in a target area and time (e.g. for an event) and who requires the statistics/predictions on the QoS/network performance and availability.

Observed experience analytics provide an indication of a service consumer experience for application traffic when routed via the 3GPP network. Examples include the average of observed Service MoS and/or variance of observed Service MoS indicating service MOS distribution for services such as audio-visual streaming as well as services that are not audio-visual streaming such as V2X and Web Browsing services.

QoS Sustainability Analytics provide information regarding the QoS change statistics for an Analytics target period in the past in a certain area, or the likelihood of a QoS change for an Analytics target period in the future in a certain area.

Network Performance Analytics provide either statistics or predictions on the gNB status information, gNB resource usage, communication performance and mobility performance in an Area of Interest.

User Data Congestion Analytics provide User Data Congestion related analytics which can relate to congestion experienced while transferring user data over the control plane or user plane or both.

In addition, in 3gpp SA6, enablement services include analytics enablement at the edge/vertical domain. More specifically:

An Application Data Analytics Enablement Service (ADAES), as specified in TS 23.436 and TS 23.434, provides analytics services for the application server or application session (e.g., between two UEs or a UE and the server) as well as analytics services for edge load/performance. One example is the collection of measurements/analytics from the UE side on QoS/QoE, as well as from 5GC and OAM, and deriving analytics (e.g., stats/predictions) on the app server performance (e.g., a gaming server, or an HOT server).

A Network Slice Capability Enablement (NSCE) service, as specified in TS 23.435 and TS 23.434, provides slice enablement services. One of these services is as specified in TS 23.435 clause 9.7 about Network slice related performance and analytics monitoring. In this service, an NSCE server collects KQI data of services, the network performance related data and the end user's information from NSCE client, as well as slice related analytics from 5GC/OAM, and exposes performance data and analytics related to the slice to the vertical customer.

A SEAL-Data Delivery (SEAL-DD) service (see, for example TR 23.700-34, TS 23.433) includes studying a specific KI (clause 4.3 of 23.700-34) of the measurement of data transmission quality (including, for example, end to end latency) between SEALDD client (UE) and SEALDD server (optionally co-located with a VAL server). Such application quality measurements can be used by the vertical server to allow for application layer service adaptions.

Other SEAL services (like network resource management) may provide translation capabilities for monitoring and allowing QoS adaptation triggering at the application layer.

Since XR services are about verticals, the enablement layer can be enhanced to support QoS/QoE translation and analytics enablement for XR applications. This can be by enhancement of existing enablers, or a new XR enabler service.

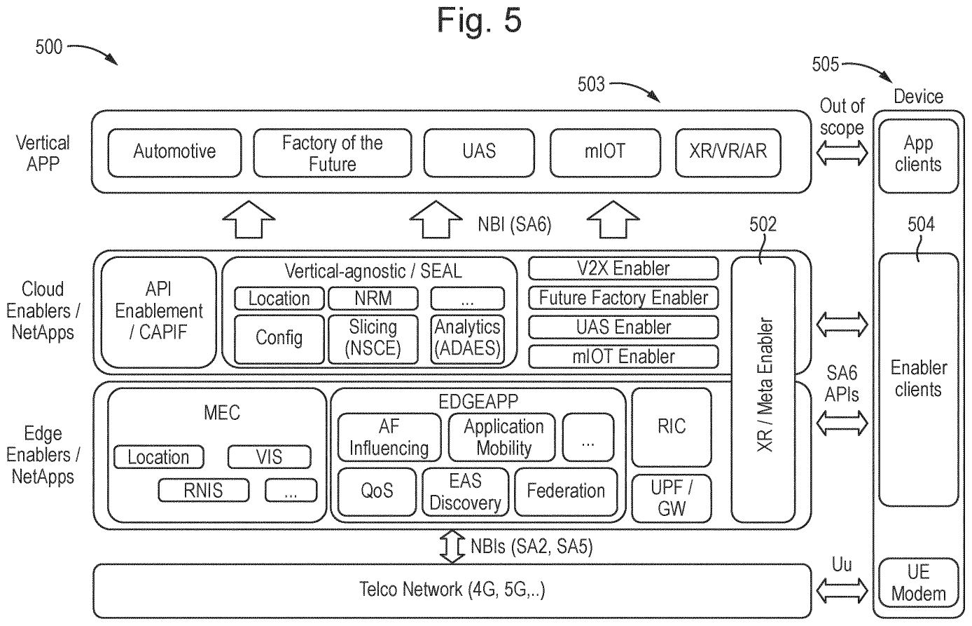

FIG. 5 is a schematic illustration showing an exemplary XR enabler service 500.

As shown in FIG. 5, the XR (e.g. Metaverse) enabler can include two logical entities/modules. These are as follows:

An XR enabler server 502 at the DN/EDN side 503 which includes the server-side middleware capabilities, for example, as a PaaS/SaaS at the edge/cloud provider or vertical domain.

An XR enabler client 504 at the UE side 505 which may provide measurements/data on the XR application session performance (e.g., for UE to UE and UE to network sessions) as well as reporting relevant data to the XR enabler server 502.

The XR enabler server 502 can be a logical entity included within any other enabler (or group of enablers) or may consume enablement services related to XR (e.g., metaverse) app services.

The XR enabler service or server or function is a newly proposed middleware entity at the platform and/or UE side which is configured to provide exposure and translation capabilities to virtual experience application services. Such capabilities may include for example the QoS requirements translation and may interact via APIs with the XR applications as well as via interfaces to the core network.

One problem to be solved is how to enable awareness on the observed service experience of the application based on the PDU set marking, and how to proactively act, for example upon an indication of possible predictive change, to ensure meeting the XRM service requirements.

The XRM service can be also defined or referred to as the XR application service or the XR service.

The XRM server, XR application server and XR server may be the same or equivalent entities.

The XR application may have server and client counterparts.

Described herein is a mechanism for XRM (e.g., mobile metaverse) tailored service optimization using analytics.

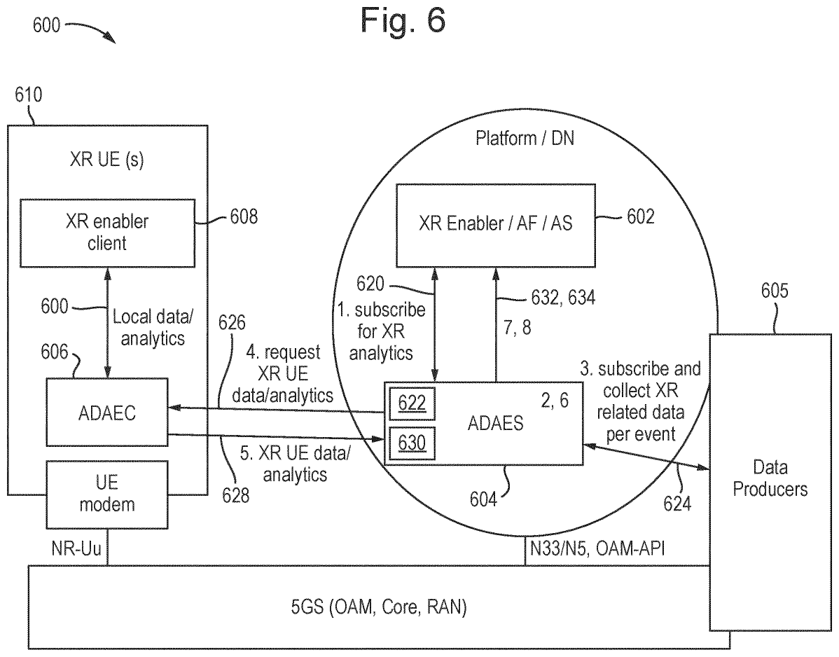

FIG. 6 is a schematic illustration illustrating this mechanism 600.

The mechanism 600, or architecture, may involve an XR server or XR enabler server 602, an ADAES 604, data producers 605, an ADAEC 606, and an XR enabler client 608. The ADAEC 606 and the XR enabler client 608 may be located (e.g. co-located) on one or more XR UEs 610.

The XR server or XR enabler server 602, the ADAES 604, the data producers 605, the ADAEC 606, and the XR enabler client 608 may be the same as or in accordance with any network entity, function, or node described herein. For example, the XR server or XR enabler server 602, the ADAES 604, and/or the data producers 605 may be the same as the network node 300 shown in FIG. 3 and described in more detail earlier above. The one or more XR UEs 610 (upon which the ADAEC 606 and the XR enabler client 608 may be located) may be the same as or in accordance with any of the UEs described herein. For example, one or more XR UEs 610 may be the same as the UE 200 shown in FIG. 2 and described in more detail earlier above.

At 620, the XR server or XR enabler server 602 subscribes to an analytics function at the DN (i.e., the ADAES 604 in this embodiment) for analytics (e.g., statistics or predictions or prescriptions) related to one or more types of traffic or PDU sets within an XR application session (or service within an XR service area). The XR session may involve multiple UEs 610 which can be remote from or close to each other. The XR session may be a Mobile Metaverse session. The PDU sets can be for given, respective traffic types (e.g., i-frames, p-frames, etc.). In some embodiments, multimodal PDU-sets are used. The subscription includes the analytics ID e.g. “XR perf analytics”, and may provide, for example: the KPIs; the needed metric to be predicted like the packet drop ratio per traffic type; expected PSDB and/or PSER; and indication whether the QoS per traffic type/PDU set is sustainable; and/or statistics within a given area of interest related to the performance of XR session (e.g., between UEs or UE-Server).

At 622, the analytics function (i.e., the ADAES 604 in this embodiment) authorizes the subscription request and determines the data to collect and the corresponding data sources. It may also determine the analytics method to be used (e.g., ML-enabled algorithms, regression, etc.). The different types of events may be identified by event IDs, and may be as defined in an appropriate standard or as discussed herein. The analytics identifier and event identifier can be the same in certain cases. For different types of events there can be different data and data sources. These may be as follows:
Event 1 (per PDU set QoS predictions): Measurements from a UE per PDU set (or different traffic types from an application of the UE), data from 5GC on QoS monitoring/QoS analytics, service experience analytics per PDU session/set of an application profile, and data from the XR server or other SEAL servers on QoS/location monitoring of the UEs.
Event 2 (per XR session QoS prediction): Measurements from UE per XR session which may be aggregated data for all sets, data from 5GC on QoS monitoring/QoS analytics, service experience analytics per application profile, data from OAM on averaged KQI data per XR service, data from the XR server on experienced XR session related performance data, and data from SEAL servers on QoS/location monitoring of the UEs.
Event 3 (app QoS sustainability for each PDU set): the data and data sources may be same as those for Event 1 above.
Event 4 (app QoS sustainability per XR session): the data and data sources may be same as those for Event 2 above.
Event 5 (predicted XR service experience): the data and data sources may be same as those for Events 1 and/or 2 above.
Event 6 (recommended PDU set parameters and importance): the data and data sources may be same as those for Event 1 above. In addition, the data may include OAM/Server configuration policies on how to derive recommendations

At 624, the analytics function (i.e., the ADAES 604 in this embodiment) subscribes to the needed data sources (i.e., data produces 605 in this embodiment) and collects data (offline and/or online). For offline data, the analytics function may use an ADRF (or A-ADRF as specified in TS 23.436) to fetch historical data/analytics related to XR sessions or per PDU set statistics.

At 626, the analytics function (i.e., the ADAES 604 in this embodiment) may also request data and/or analytics from the analytics client (i.e., the ADAEC 606 in this embodiment) at the XR users' side. This request may include a data collection ID or the analytics ID (or event ID), and the needed data to be collected (e.g., QoS data, QoE data) or analytics on this data (e.g., predictions, statistics) using locally derived measurements from application of the XR UEs 610 as well as from enabler client 608/UE modems. In the case of analytics, this request may comprise the method to be used, the confidence level, the type of analytics (e.g., real-time, offline, etc.), and/or the way of reporting (e.g., based on a threshold such as a predicted QoS downgrade, or periodic reporting, or when an XR session is terminated/established).

At 628, the analytics function receives analytics from the UE based on the request.

At 630, the analytics function (i.e., the ADAES 604 in this embodiment), based on data collected at steps 606 and 608, categorizes the data based on whether these are per PDU set, type of traffic in the XR session, and/or averaged per XR session. The data may also be categorized dependent on whether these are raw data or analytics/processed data. The analytics function (i.e., the ADAES 604 in this embodiment) prepares the data based on the expected output. The analytics function (i.e., the ADAES 604 in this embodiment) may abstract, process, and/or combine the data to derive analytics on the needed analytics ID (based on the above events). In the case of prescriptive analytics, the analytics function (i.e., the ADAES 604 in this embodiment) interprets, using e.g. appropriate logic, a predicted metric into an action for the application or network layer. An example is the prescription of changing the encoding rate for video traffic based on the predicted metric, while ensuring acceptable performance for all entities involved in the XR session.

At 632, the analytics function (i.e., the ADAES 604 in this embodiment) may send the analytics output to the analytics consumer. In this embodiment, the analytics consumer is the XR server or the XR enabler server 602. In other embodiments, the consumer may include an NF which may use such analytics to trigger pro-actively an adaptation of the QoS parameters related to the PDU set or XR session.

At 634, in the case of prescriptive analytics, the analytics function (i.e., the ADAES 604 in this embodiment) may also interact with the XR AF/AS 602 (as defined in TR 26.928) to provide guidance on adapting the encoding rate for the video traffic sessions or to recommend the change of encoder configuration or change of the PDU-set grouping configuration.

Thus, the mechanism 600 for XRM tailored service optimization using analytics is provided.

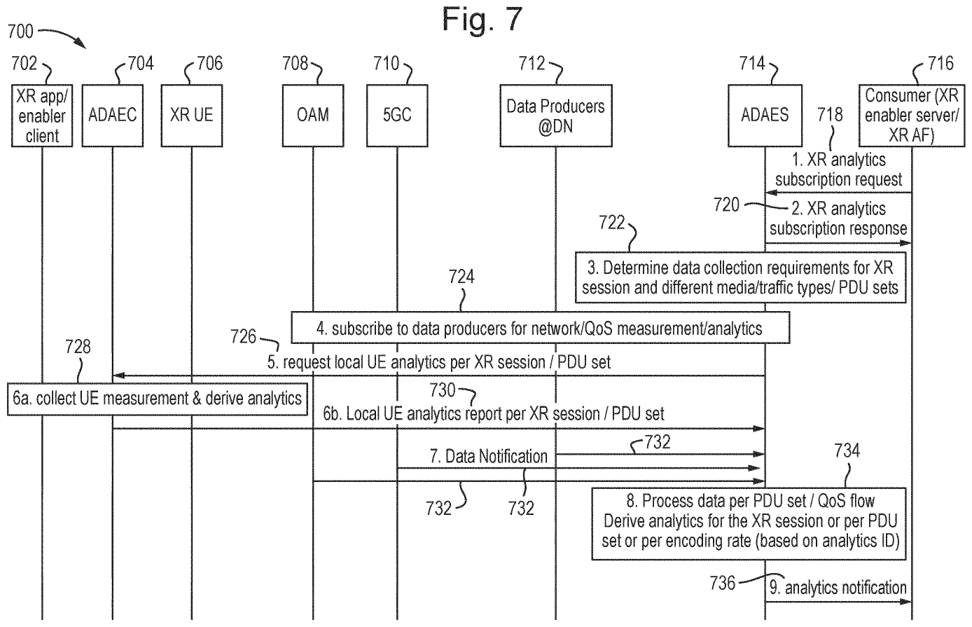

What will now be described, with reference to FIG. 7, is an embodiment in which the ADAES provides a capability to the XR enabler/XR server/XR AF. This capability includes the use of analytics per PDU set/media type or per XR session, or even for a target encoding rate target/video quality. The predicted parameter may include the packet drop ratio per PDU set/traffic type, or statistics on PSDB and PSER, etc. This may also include translating of per PDU set expected performance to XR service performance, so as to predict service experience using per PDU set analytics/data.

FIG. 7 is a schematic illustration illustrating a process 700 in which the ADAES 714 provides a capability to the XR enabler/XR server/XR AF 716.

The process 700 may involve an XR application/enabler client 702, an ADAEC 704, an XR UE 706, OAM 708, a 5GC 710, data producers 712, an ADAES 714, and an analytics consumer 716 (e.g., XR enabler/XR server/XR AF).

The XR application/enabler client 702, the ADAEC 704, the XR UE 706, the OAM 708, the 5GC 710, the data producers 712, the ADAES 714, and the analytics consumer 716 may be the same as or in accordance with any network entity, function, or node described herein. For example, XR application/enabler client 702, the ADAEC 704, the XR UE 706, the OAM 708, the 5GC 710, the data producers 712, the ADAES 714, and the analytics consumer 716 may be the same as the network node 300 shown in FIG. 3 and described in more detail earlier above. The XR UE 706 may be the same as or in accordance with any of the UEs described herein. For example, XR UE 706 may be the same as the UE 200 shown in FIG. 2 and described in more detail earlier above.

At 718, the analytics consumer 716 (e.g., XR enabler/XR server/XR AF/NF) sends an analytics subscription request to the ADAES 714. This request may indicate the analytics ID, the event ID, the consumer ID, the PLMN ID, the list of the VAL UEs for which the service applies, the XR service/application ID or profile, the media types supported, the traffic requirement, the encoding rate(s) for which the analytics apply, the area of interest, and/or the time of interest. The consumer 716 may also send the motion profile (e.g., stationary/nomadic, slow moving, fast moving; in-house/deep in-house) for the XR users within the XR session.

At 720, the ADAES 714 authorizes the request and sends an analytics subscription response with a positive or negative acknowledgement back to the consumer 716.

At 722, the ADAES 714 determines the data to be collected and the data producers 712 to be used per traffic type/media type or collectively per XR session. This may be done based on the Analytics ID. The ADAES 714 may also determine the Data Collection Event IDs and the mapping to the data producer IDs/addresses, as well as the data required from the database/ADRF. The data collection can be also decided to be done via A-DCCF or directly with the Data Producers. For XR sessions, the data needed for different traffic types can be as follows:
For video data: latency, PER, XR MOS, stalling events, stalling ratios, throughput, PSDB and PSER, encoding rate/video quality, min-max frame rate, other QoE aspects.
For sensor data: e2e latency, availability, reliability, data freshness, group/clustering info and connection density.
For haptics-related data: Packet Size, Reliability (%), Latency (ms), Average Data rate.
Per PDU set: PSDB and PSER, encoding rate/video quality per set, importance factor/priorities, packet drop rates per PDU set, jitter.
For XR sessions: QoE metrics including immersion (“credibility” of XR effects), application QoS metrics (e.g., latency, jitter, reliability, rate, etc.) which may be aggregated or min-max per XR session, roundtrip interaction delay, user interaction delay.

At 724, the ADAES 714 subscribes to the data sources (i.e. data producers 712) that were identified or determined in step 722.

At 726, the ADAES 714 sends a request to the XR capable UEs (supporting ADAEC 704) within the service area, to configure the monitoring of specific QoS/QoE data or analytics and to provide information based on the analytics event or the data collection event.

At 728, the ADAEC 704 may locally collect data or analytics based on the request received at step 726. Such analytics can be generated the per PDU set, per encoding rate, per XR session, and/or per media type by the UE (or group of UEs) as perceived by the target UE (the one that is deploying ADAEC).

At 730, based on the collection, and the configuration of the reporting in step 726, the ADAEC 704 sends a data or analytics notification to the ADAES 714 based on the analytics ID. This notification may include a predicted performance change or a QoS/QoE attribute change based on a pre-defined threshold being reached, or can be local UE statistics that can be provided one time or periodically.

At 732, the data producers 712 provide the required or requested data based on to subscription as determined in step 722. This data can, for example, be from one or more of the following entities:
The OAM 708. The data may include performance data for the XR service (assuming a given service profile), PM/FM analytics, and/or KPI/KQI monitoring events, etc.
The 5GC 710. The data may include network/QoS analytics from an NWDAF via NEF, and/or network/QoS monitoring events from the NEF, etc.
The XR server. The data may include server performance data for the XR session or per PDU set or per media or traffic type, and/or encoding rate associated with the performance data, etc.
An XR application at UE (e.g., indirectly via server/AF). The data may include user performance data for the XR session, or per PDU set, or per media or traffic type, and/or encoding rate associated with the performance data, etc.
A DCAF. The data may include media performance data if DCAF supports the collection of media user data directly or indirectly via the XR server.
An A-ADRF. The data may include offline statistics or historical data/analytics on the per PDU set or per traffic/media type or per XR session performance.

At 734, the ADAES 714, after receiving the data, processes the data, e.g. based on the type and the granularity, and derives analytics based on the analytics event/ID.

At 736, the ADAES 714 sends the analytics output to the analytics consumer 716. In the case of prescriptive analytics, the notification may be in the form of guidance, recommendation, instruction, or command on the encoding rate configuration or the PDU set group adaptation for the target XR application or one or more XR users within the application service.

The analytics consumer 716 may perform an action in response to receiving the analytics output from the ADAES 714. For example, the analytics consumer 716 may act in accordance with, or follow, the guidance, recommendation, instruction, or command, thereby, for example, adapting an encoding rate or PDU set.

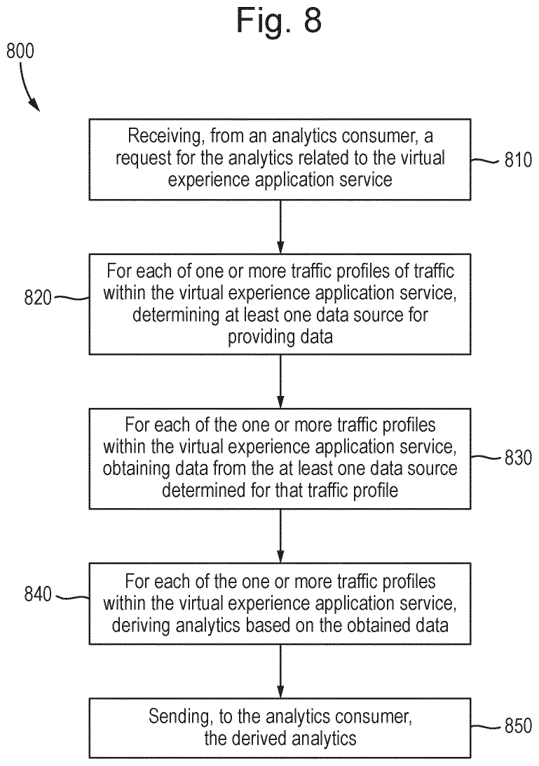

In an aspect, there is provided a method performed in an application entity of a wireless communication system. FIG. 8 is a process flow chart showing certain steps of the method 800. In certain embodiments, the method 800 may be performed by a processor executing program code, for example, a microcontroller, a microprocessor, a CPU, a GPU, an auxiliary processing unit, a FPGA, or the like. The method 800 is for determining analytics in relation to a virtual experience application service or session. For example, the method 800 may be for determining analytics in relation to an application quality QoS/QoE, as opposed to a network QoS/QoE. Analytics related to application QoS/QoE may be related to, characterise, or represent performance between two application entities (e.g., as opposed to between a UE and a network). The virtual experience application service or session may include, for example, an XR application service or session, an AR application service or session, an MR application service or session, or a metaverse application service or session. The method 800 comprises: receiving 810, from an analytics consumer, a request for the analytics related to the virtual experience application service or session; for each of one or more traffic profiles of traffic within the virtual experience application service, determining 820 at least one data source (e.g., a data producing entity, or a database) for providing data; for each of the one or more traffic profiles within the virtual experience application service, obtaining 830 data (such as service and/or network data) from the at least one data source determined for that traffic profile; for each of the one or more traffic profiles within the virtual experience application service, deriving 840 analytics (e.g. performance or QoS/QoE analytics related to the virtual experience application service or session) based on the obtained data; and sending 850, to the analytics consumer, the derived analytics.

The analytics consumer may comprise an application and/or network entity. In some embodiments, the network entity may be a network management function or service.

The request may be received as part of an analytics subscription request e.g. made by the analytics consumer.

The request may be received as received as part of a request, message, or package comprising one or more parameters selected from the group of parameters consisting of: an analytics identifier; an event identifier (e.g. identifying a requested analytics event); an identifier of the analytics consumer; a public land mobile network, PLMN, identifier; a list of user equipment apparatuses, UEs, for which the virtual experience application service or session applies; an identifier of the virtual experience application service or session; an indication of media type supported by the virtual experience application service or session; a traffic requirement; one or more encoding rates for which the analytics apply; a service area, e.g. an area of interest; an analytics method for deriving the analytics; a type of analytics; and a time period, e.g. a time period of interest/validity.

The method 800 may further comprise determining an analytics method (e.g., an ML-enabled algorithm, regression, etc.) to be used to derive the analytics. This analytics method may then be applied to determine the analytics.

The determining of the at least one data source may comprise mapping a received analytics identifier to the at least one data source, e.g. to an identifier or address of the data producing entity.

The method 800 may further comprise subscribing to receiving data from the at least one data source.

The obtaining of the data may comprise: sending, to a remote entity (e.g. to an ADAEC), a request for local data or analytics (e.g. local UE analytics) for each of the one or more traffic profiles within the virtual experience application service or session; and, in response to the request for local analytics, receiving the requested local data or analytics.

Each of the at least one data source may be a data source selected from the group of data sources consisting of: a user equipment, UE; a network function, NF, e.g. a DCAF; a management function, e.g. an OAM; an extended reality server; an application entity, e.g. an XR application at a UE; a source of historical data, e.g. A-ADRF; and/or a combination thereof.

The obtained data may comprise data selected from the group of data consisting of: service data; network data; measurements analytics; network analytics; performance data for the virtual experience application service or session; an encoding rate associated with the performance data; PM/FM analytics; KPI/KQI monitoring events; QoS analytics; server performance data, e.g. for the virtual experience application service or session or per PDU set or per media or traffic type; an encoding rate associated with the server performance data; user performance data, e.g. for the virtual experience application service or session or per PDU set or per media or traffic type; an encoding rate associated with the user performance data; media performance data; offline statistics; and historical data or analytics, for example per PDU set or per traffic/media type or per XR session.

Each traffic profile may indicate, specify, or comprise one or more of the following: a PDU-set; a media type; video traffic; audio traffic; a traffic type; an XR application profile; a multimodal PDU session; an application session; an encoding rate, e.g. a target encoding rate; a video quality; and/or a combination thereof.

The method 800 may further comprise causing (e.g., prescribing, or by providing guidance/a recommendation/an instruction) an adaption of an encoding rate (e.g., an encoding rate for media type or video traffic according to the traffic profile) based on the derived analytics.

The method 800 may further comprise causing (e.g., prescribing, or by providing guidance/a recommendation/an instruction) a change in a configuration of an encoder and/or of PDU-set grouping (e.g. of media type or video traffic according to the traffic profile) based on the derived analytics.

In a further aspect, there is provided an application entity for a wireless communication system. The application entity comprises: a transceiver; and a processor coupled to the transceiver, the processor and the transceiver configured to cause the apparatus to: receive, from an analytics consumer, a request for the analytics related to a virtual experience application service (e.g., an XR application session); for each of one or more traffic profiles of traffic within the virtual experience application service, determine at least one data source (e.g. a data producing entity, or a database) for providing data; for each of one or more traffic profiles of traffic within the virtual experience application service, obtain data (e.g. service and/or network data) from the at least one data source determined for that traffic profile; for each of one or more traffic profiles of traffic within the virtual experience application service, derive analytics (e.g. QoS analytics) based on the obtained data; and send, to the analytics consumer, the derived analytics.

The application entity may be an ADAES.

XRM services comprise different types of traffic types, with diverse KPIs. For example, an XR service/session may include video, audio, haptics, sensor traffic, and/or may involve multiple XR users. The configuration of the network/QoS parameters for an XR session and in particular for dynamic environments (where one or more remote XR users are expected to move) tends to be a challenging task. The above-described systems and methods tend to ensure that the XR application QoS/QoE requirements are met, with the support of analytics.

The above-described apparatuses and methods advantageously tend to provide a new capability at an analytics enabler server, procedures for collecting data related to XR specific attributes, and deriving performance analytics per PDU set/media or traffic type or even per XR session. Such data can be collected real time by the XR UEs and also by the 5GS and/or DN. The derivation of analytics can provide insight on the expected/predicted performance per XR session as well as per PDU set/traffic type, and may also help recommending PDU set QoS configurations to the XR AF/XR AS.

Current analytics services in the NWDAF as well as the ADAES do not cover the service experience/application QoS prediction for the case when a session supports multiple traffic types or for the case of requested analytics per PDU set. This tends to necessitate the data collection of diverse data/analytics from multiple domains and additional translation/processing capabilities at the enablement layer for intelligently determining a predictive metric to allow the proactive adaption of PDU set QoS parameters to ensure meeting the XR session requirements.

In embodiments described herein, an XR tailored analytics capability is provided. Also, procedures performed by the ADAE layer are provided.

Further aspects of the invention are provided by the subject matter of the following clauses:

1. A method at an application entity for performing analytics on the quality level of one or more extended reality applications. The method comprises: receiving a requirement for deriving XR session related analytics; determining at least one data collection requirement for a plurality of traffic profiles within the XR session, wherein the data collection requirement indicates at least one data producing entity per traffic profile; obtaining service and/or network data based on the at least one data collection requirement for one or more traffic profiles; deriving per traffic profile application QoS analytics based on the obtained service and/or network data; and sending an analytics output based on the derived analytics for one or more traffic profiles within the XR session.

2. The method of any preceding clause, wherein the receiving a requirement is provided by an application and/or network entity.

3. The method of any preceding clause, wherein the requirement is received as part of an analytics subscription request.

4. The method of any preceding clause, wherein the analytics subscription request comprises an analytics ID, a service area, a requested analytics method, a requested analytics event, a type of analytics, a time of validity, and/or at least one UE for which the analytics applies.

5. The method of any preceding clause, wherein the data collection requirement comprises a mapping of the analytics ID to at least one data collection identifiers.

6. The method of any preceding clause, further comprising subscribing to at least one data producer per traffic profile.

7. The method of any preceding clause, wherein obtaining service/network data comprises requesting and receiving data from a user equipment, a network function, a management function, an XR server, an application entity, or a combination thereof.

8. The method of any preceding clause, wherein the service/network data are measurements and/or network analytics.

9. The method of any preceding clause, where the traffic profile comprises a PDU set, a media type, a traffic type, an XR session, a multimodal PDU session, an application session, or a combination thereof.

10. The method of any preceding clause, further comprising prescribing an adaption of the encoding rate based on the derived analytics.

11. Analytics related to the traffic profile for a given encoding rate/configuration, or for multiple encoding rates.

12. An analytics event as herein described.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document:
UE User Equipment
PDU-set Protocol Data Unit set
UL Uplink
DL Downlink
QoS Quality of Service
XR Extended Reality
PSDB PDU Set Delay Budget
PDB Packet Delay Budget
PSER PDU Set Error Rate
NWDAF Network Data Analytics Function
UPF User Plane Function
SMF Session Management Function
ADAES Application Data Analytics Enablement Server
ADAEC Application Data Analytics Enablement Client
XRM XR and Media
SEAL Service Enabler Architecture Layer
MOS Mean Opinion Score

1. A method in an application entity of a wireless communication system, the method comprising:
receiving, from an analytics consumer, a request for analytics related to a virtual experience application service associated with one or more traffic profiles of traffic within the virtual experience application service;
determining at least one data source for providing data for each traffic profile of the one or more traffic profiles;
deriving analytics for each traffic profile of the one or more traffic profiles based on data obtained from the determined at least one data source for each traffic profile; and
sending, to the analytics consumer, the derived analytics.

2. The method of claim 1, wherein the analytics consumer comprises an application or a network entity.

3. The method of claim 1, wherein the request for analytics is included in an analytics subscription request.

4. The method of claim 1, wherein the request for analytics is received as part of a request comprising one or more parameters selected from:
an analytics identifier (ID);
an event ID;
an ID of the analytics consumer;
a public land mobile network(PLMN) ID;
a list of user equipments (UEs) for which the virtual experience application service applies;
an ID of the virtual experience application service;
an indication of media type supported by the virtual experience application service;
a traffic requirement;
one or more encoding rates for which the analytics apply;
a service area;
an analytics method for deriving the analytics;
a type of analytics; or
a time period.

5. The method of claim 1, further comprising determining an analytics method to be used to derive the analytics.

6. The method of claim 1, wherein the determining the at least one data source comprises mapping a received analytics identifier (ID) to the at least one data source.

7. The method of claim 1, further comprising subscribing to receiving data from the at least one data source.

8. The method of claim 1, wherein to obtain the data from the determined at least one data source for each traffic profile, the method further comprises:
sending, to a remote entity, a request for local data or analytics for each of the one or more traffic profiles within the virtual experience application service; and
receiving the local data or analytics in response to the request for local analytics.

9. The method of claim 1, wherein each of the at least one data source is a data source selected from:
a user equipment (UE);
a network function (NF);
a management function;
an extended reality server;
an application entity;
a source of historical data; or
a combination thereof.

10. The method of claim 1, wherein the data obtained from the determined at least one data source for each traffic profile comprises data selected from:
service data;
network data;
measurements analytics;
network analytics;
performance data for the virtual experience application service;
an encoding rate associated with the performance data;
performance management and fault management (PM/FM) analytics;
key performance indicator and key quality indicator (KPI/KQI) monitoring events;
quality of service (QoS) analytics;
server performance data;
an encoding rate associated with the server performance data;
user performance data;
an encoding rate associated with the user performance data;
media performance data;
offline statistics; or
historical data or analytics.

11. The method of claim 1, wherein each traffic profile indicates one or more of:
a protocol data unit set (PDU-set);
a media type;
a video traffic;
audio traffic;
a traffic type;
an extended reality (XR) application profile;
a multimodal protocol data unit (PDU) session;
an application session;
an encoding rate;
a video quality; or
a combination thereof.

12. The method of claim 1, further comprising causing an adaption of an encoding rate based on the derived analytics.

13. The method of claim 1, further comprising causing a change in a configuration of an encoder and/or of protocol data unit set (PDU-set) grouping based on the derived analytics.

14. An application entity for wireless communication, the application entity comprising:
a memory; and
a processor coupled with the memory and configured to cause the application entity to:
receive, from an analytics consumer, a request for the analytics related to a virtual experience application service associated with one or more traffic profiles of traffic within the virtual experience application service;
determine at least one data source for providing data for each traffic profile of the one or more traffic profiles;
derive analytics for each traffic profile of the one or more traffic profiles based on the obtained-data obtained from the determined at least one data source for each traffic profile; and
send, to the analytics consumer, the derived analytics.

15. The application entity of claim 14, wherein the application entity is an Application Data Analytics Enablement Server (ADAES).

16. The application entity of claim 14, wherein the analytics consumer comprises an application or a network entity.

17. The application entity of claim 14, wherein the request for the analytics is included in an analytics subscription request.

18. The application entity of claim 14, wherein the request for the analytics is received as part of a request comprising one or more parameters selected from:
an analytics identifier (ID);
an event ID;
an ID of the analytics consumer;
a public land mobile network (PLMN) ID;
a list of user equipments (UEs) for which the virtual experience application service applies;
an ID of the virtual experience application service;
an indication of media type supported by the virtual experience application service;
a traffic requirement;
one or more encoding rates for which the analytics apply;
a service area;
an analytics method for deriving the analytics;
a type of analytics; or
a time period.

19. The application entity of claim 14, further comprising determining an analytics method to be used to derive the analytics.

20. The application entity of claim 14, wherein the determining the at least one data source comprises mapping a received analytics identifier (ID) to the at least one data source.
